(19) United States
(12) Patent Application Publication
(10) Pub. No.: US 2019/0256261 A1
(43) Pub. Date: Aug. 22, 2019

(54) CONTAINER, SEAL WITH BLISTER ELEMENT, AND SCOOP THEREFOR

(71) Applicant: N.V. Nutricia, Zoetermeer (NL)

(72) Inventors: Wido van Drecht, Utrecht (NL); Maria Bernabe Betancor, Utrecht (NL)

(73) Assignee: N.V. Nutricia, Zoetermeer (NL)

(21) Appl. No.: 16/344,044

(22) PCT Filed: Oct. 25, 2017
(86) PCT No.: PCT/EP2017/077363

§ 371 Date: Apr. 23, 2019

(30) Foreign Application Priority Data
Oct. 25, 2016 (EP) PCT/EP2016/075706

(51) Int. Cl. B65D 51/24; B65D 51/18; B65D 8/00; B65D 21/02; B65D 85/00; B65B 1/02; B65B 1/04; B65B 7/01; A23L 33/00; G01F 19/00

(52) U.S. Cl. CPC B65D 51/247; B65D 51/18; B65D 7/04; B65D 21/022; B65D 85/70; B65B 1/02; A23V 2002/00; B65B 7/01; A23L 33/40; G01F 19/002; B65D 2251/0018; B65D 2251/0093; B65B 1/04

(57) ABSTRACT

A container for a powdered nutritional product is provided, the container comprising a can having a base and an upstanding sidewall defining an interior space, the sidewall extending to a rim defining an opening to the interior space, a seal attached to the rim and serving to sealingly close the opening, wherein the seal is provided with a scoop recess formed between the seal and a blister element connected to the seal. Additionally, a lid is provided having an upper part and a lower part, wherein the lower part has a greater radius than the upper part, and wherein the radius of the upper part is smaller than the radius of the rim of the can. Further, a scoop is provided for use with the described container, the scoop comprising a bowl and a handle attached to an upper part of the bowl, the handle extending downwardly away from the bowl forming a downward extension until reaching a deflection point, and extending horizontally away from the bowl from said deflection point thereby forming a horizontal extension.

### FIELD OF THE INVENTION

The present invention relates to packaging containers for powdered nutritional products, and in particular relates to containers for infant formula, or other powdered food products.

### BACKGROUND ART

Such containers are well-known. However, the known container suffers several drawbacks which have an impact on issues such as the hygienic use of the container, the perceived freshness of the contained product, and convenient consumption and preparation of the food product.

A problem with the known container is that the scoop is normally provided within the powdered food product itself. In such containers, a scoop is dropped into the empty container during production, and thereafter the powdered food product is dispensed into the container. This results in a scoop that is buried within the food product. If that is the case, the easiest way for a consumer to retrieve the scoop is by inserting their hand into the container. Alternatively, they may have to find an implement to do so. In the best case scenario, this at least adds the step and time of washing and/or desinfecting hands or the implement used for retrieval of the scoop. If the hands (or implement) are not washed or are not washed properly, the product may become contaminated with external agents during retrieval of the scoop. In the case of powdered infant formula, this should be avoided as much as possible in view of the infant's immature, developing immune system. Adding to these drawbacks, the consumer will also have to spend time washing their hands or implement after retrieval of the scoop from the can. This process of retrieving the scoop may result in a perception of the container as unhygienic. Moreover, such a container may be perceived as somewhat wasteful, as some powdered food product may adhere to the hands or implement used for retrieval of the scoop, and this might entail a loss of food product.

For this reason, consumers may prefer that the scoop be initially provided in a manner in which it is not in contact with the powder or food product in the container.

Other containers are known in which the scoop is provided in the lid with a holding element, and therefore the scoop is not in contact with the powdered food product during initial retrieval. While such a container facilitates retrieval of the scoop, the container is bulky and expensive due to the greater amount of material used in the lid. Attempts have been made at improving such arrangements, but these still have drawbacks.

However, this is disadvantageous because the lid must be made high enough to accommodate the entire volume of the scoop. This is because the can must be sealed at the rim in order to preserve the freshness of the product during transport and sale.

Another problem with the scoops typically provided with the known containers is that of dosing or measuring accuracy. This is of particular importance to parents or caregivers of infants who have to dose the correct amount of infant formula according to the nutritional needs of the infant as laid down in nutritional legislation. Such information on the nutritional needs is typically taken into consideration by nutritionists that have calculated the correct amounts of a particular commercially available infant formula to be dosed. During dosing the powdered food, product may accumulate on the handle, particularly in the area of the handle nearest to the bowl. To prevent incorrect dosing, this excess product would have to be manually removed by the consumer and further, the consumer will most likely prefer to drop back any excess product into the can. Not only is this time-consuming, but it can also expose the reintegrated product and the product in the can to external agents.

Moreover, the known containers further require additional material than for a standard container where accuracy is not needed, because a leveling part is provided which extends from the rim of the can.

Therefore, there is a need for an improved container which allows consumers to more conveniently retrieve a scoop and use of the product, while avoiding high manufacturing costs.

### SUMMARY OF THE INVENTION

According to the present invention, a container for a powdered nutritional product, the container comprising a can having a base and an upstanding sidewall defining an interior space, the sidewall extending to a rim defining an opening to the interior space, a seal attached to the rim and serving to sealingly close the opening, wherein the seal is provided with a scoop recess formed between the seal and a blister element connected to the seal.

By providing a scoop recess on the seal, contact between the scoop and the powdered nutritional product is prevented. The blister element is preferably attached to the underside of the seal, that is, the side of the seal that faces the inside of the container. Providing the scoop inside such a blister allows the consumer to easily retrieve the scoop, while avoiding the need for any hand contact with the food product during retrieval of the scoop. Such a container can be advantageously used as a container for infant formula. The blister element is preferably formed of a relatively rigid material, while the seal is preferably formed of a relatively flexible material as it needs to be peeled off, The blister element may be formed of polyethylene terephthalate (PET). Alternatively, the blister element may be formed of any material that would be suitable for use in food product containers. The seal may comprise a material such as aluminium, or any other material suitable for use in food product containers which is known to the skilled person.

In an embodiment, the container further comprises a lid, connectable to the can to cover the seal and/or to close the opening. The height between a lower surface of the lid and an upper surface of the seal is less than the height of the scoop. The height of the scoop is defined herein as the highest point of the scoop when the scoop is disposed horizontally. This may also be referred to as the minor dimension of the scoop. The highest point will normally be found along the bowl of the scoop. Since the scoop is provided within the can itself, the lid need not be as high as the lid in known containers in which the scoop is provided between the lid and the seal of the can. This reduces the amount of material for manufacturing the lid, and decreases the overall weight and size of the container with lid reducing storage space needs and transport costs. In a preferable embodiment, the height of the lid is no more than 15 mm.

In an embodiment, the seal comprises a pulltab for peeling off the seal from the can. This provides a convenient gripping point for the consumer to peel the seal off the can. The pull tab may be arranged to extend back on top of the seal, or to protrude away from the seal.

According to an embodiment, the scoop recess within the blister is elongate, defining a longitudinal axis. This will correspond closely to the length or major dimension of the scoop. The pulltab may be provided in a substantially perpendicular relation to the longitudinal axis of the blister. The longitudinal axis of the blister is defined herein as that axis along the greatest length of the blister. This minimizes the interference or resistance from the blister along the peel-off direction (resulting from the relative rigidity of the blister material) when the seal is being pulled off and as such reduces undesired ripping of the seal. For a circular seal, the blister may be aligned across a diameter of the seal and the pull tab may allow removal of the seal in a direction transverse to this diameter.

According to a further embodiment, the lid has an upper part and a lower part, wherein the lower part has a greater radius than the upper part, and wherein the radius of the upper part is smaller than the radius of the rim of the can. This enables convenient stacking of the lids, which can be advantageous during as assembly process. This also reduces the material and manufacturing costs of the lid.

In a further embodiment, the upper part of the lid has a profiled outer circumference that is complementary with the base of the container, allowing stacking therewith. This enables convenient stacking of multiple containers during transport and/or during commercial or household storage In an embodiment, the lid comprises a holding element for holding the scoop, which can be arranged to receive a scoop that has been removed from the scoop recess.

According to an embodiment, the lid is circular and the holding element may be arranged to hold the scoop in any diametric orientation with respect to the lid. This allows for faster and convenient storage of the scoop on the lid, as there is no need for the user to align the scoop with respect to the holding element.

According to a further embodiment of the invention, a seal and blister element containing a scoop is provided, which can be conveniently attached to the rim of any can or container. Preferably, the can or container is a metal, cylindrical as regularly used in the field of infant formulae having a diameter of between 90 and 130 mm. Typically, such metal cans have a standard diameter of 99 or 127 mm. The seal, blister element and lid of the present invention are preferably adapted to fit such a metal can.

According to a further embodiment of the invention, a scoop is provided for use with the described container, the scoop comprising a bowl and a handle attached to an upper part of the bowl, the handle extending downwardly away from the bowl forming a downward extension until reaching a deflection point, and extending horizontally away from the bowl from said deflection point thereby forming a horizontal extension. Having the handle attached to the upper part of the bowl provides a surface that conveniently with leveling of the product in the scoop. Further, providing a handle that is to the bottom of the bowl facilitates storage of the scoop on the lid in a position in which the bowl opening faces downward toward the food product. This allows food product remnants in the scoop to fall back into the container. Alternatively, the handle may be attached to the bowl near the bottom of the bowl. The deflection point may be located substantially at the same height as the bottom of the bowl or it may be located above the height of the bottom of the bowl. The downward handle extension may have a curvature, which further facilitates leveling of the scoop.

In an embodiment, the downward extension of the handle is at least partly bifurcated into two subextensions, so that the handle is attached to the bowl at two separate locations, each of the two subextensions having a width that is smaller than the width of the horizontal extension of the handle. The downward extension may alternatively be trifurcated, or separated into any number of extensions. A handle that is not so wide near its attachment to the bowl of the scoop prevents the accumulation of powdered food product on the handle. In an embodiment, the downward extension of the handle and the horizontal extension are continuous or integrated formed.

In an embodiment, the height of the bowl increases gradually from a substantially central point on the sides of the bowl towards the front of the bowl and towards the handle of the scoop. thereby forming concave, curved sides, so that the scoop can be leveled against the rim of the can.

In an embodiment, an opening in the handle for attaching the scoop to an underside of the lid.

### SHORT DESCRIPTION OF DRAWINGS

The present invention will be discussed in more detail below, with reference to the attached drawings, in which

FIG. 1 schematically depicts a container according to an embodiment of the invention.

FIG. 2 schematically depicts a seal with a blister element and a scoop according to a further embodiment the invention.

FIG. 3 schematically depicts a lid for a container according to an embodiment of the invention.

FIG. 4 schematically depicts a scoop according to an embodiment of the invention.

FIG. 5 schematically depicts a process of manufacture of a blister element on a seal and a container and according to an aspect of the invention.

### DESCRIPTION OF EMBODIMENTS

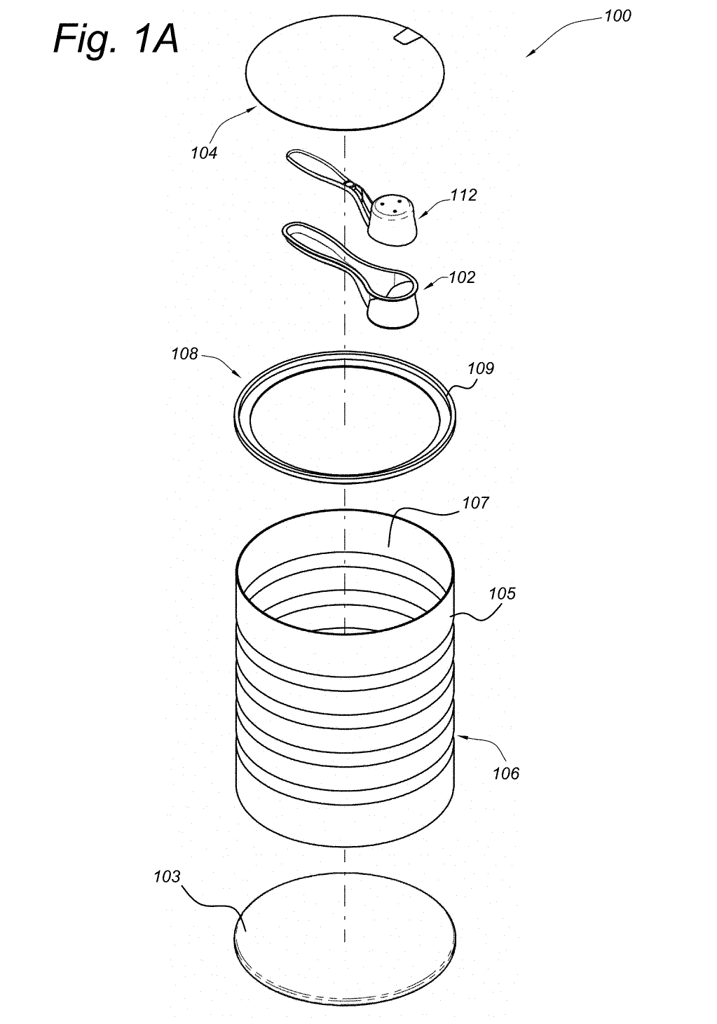

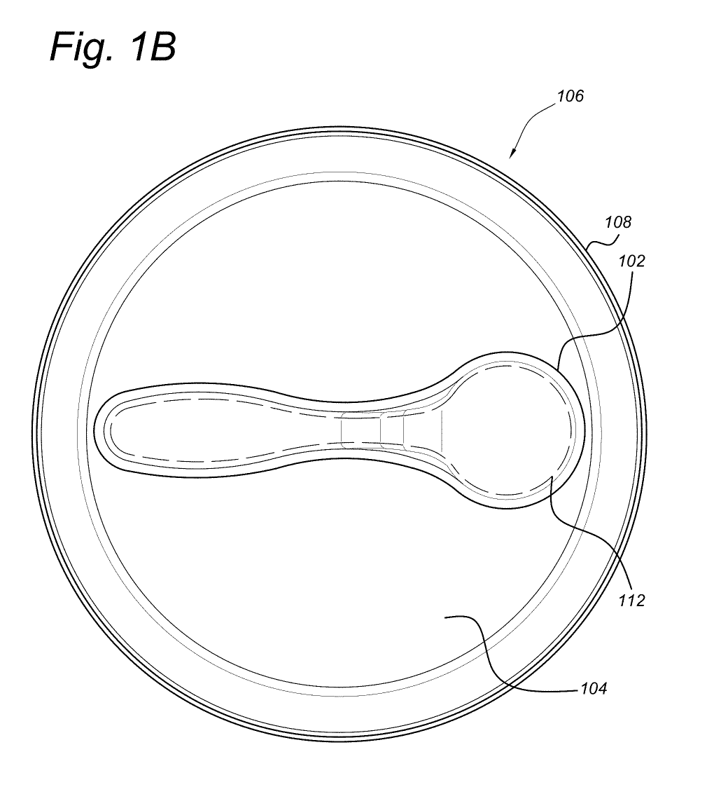

FIG. 1 shows a container 100 according to an exemplary embodiment of the invention, the container 100 being provided with a blister element 102 for attachment onto a seal 104. The container has a base 103 a sidewall 105 defining an interior space 107. The seal 104 is on a can 106. The can 106 has a rim 108, and a bottom panel 110. The rim 108 has an upper edge 109, the rim defining an opening 111. The blister element 102 contains a scoop 112. A top-view of the can 106 is also shown. The blister element 102 which is provided on a seal 104 has been attached to the rim 106 of the can 106, and contains a scoop 112.

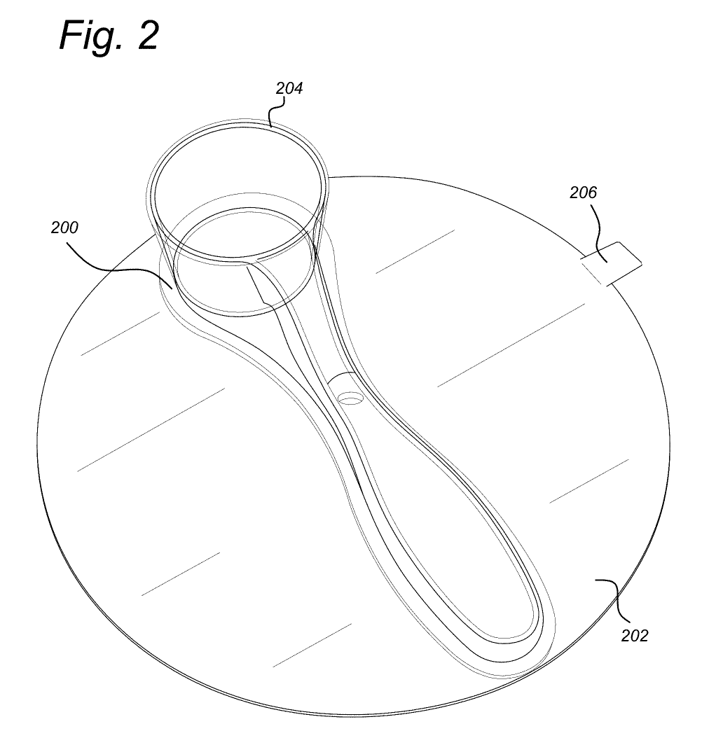

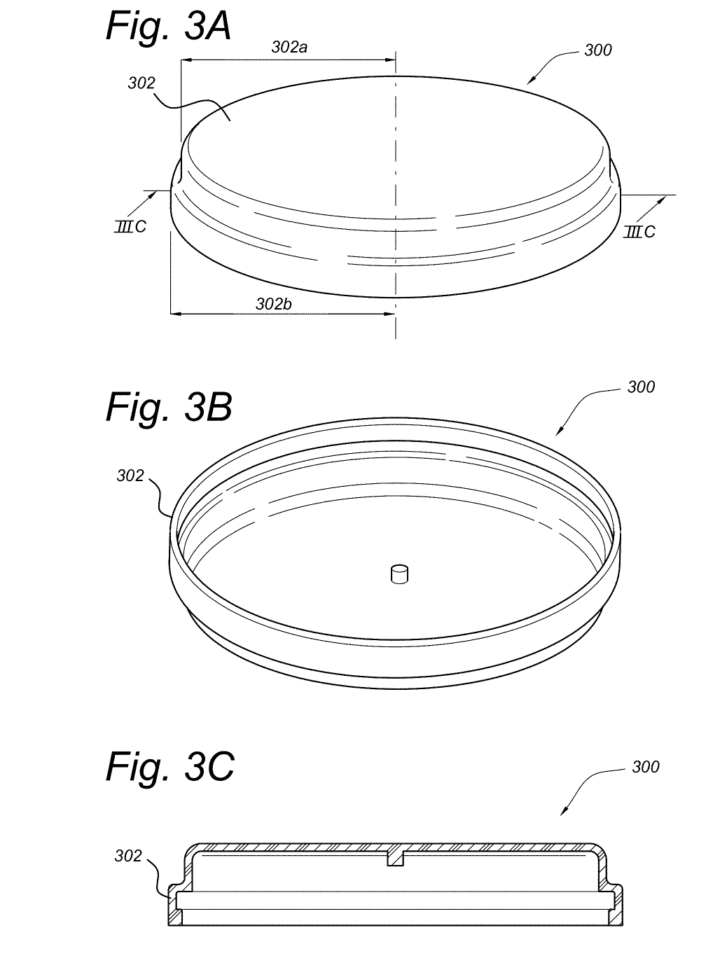

FIG. 2 shows a blister element 200 holding a scoop provided on a seal 202 according to an exemplary embodiment of the invention. The blister element 200 holds a scoop 204. The seal 202 has an upper surface 203 further comprises a pulltab 206. FIG. 3 shows a lid 300 having a stepped, vertical cross-section. The lid 300 has an upper part 302 with a radius 302a, and a lower part 304 with a radius 304a. The radius 302a is smaller than the radius 304b.

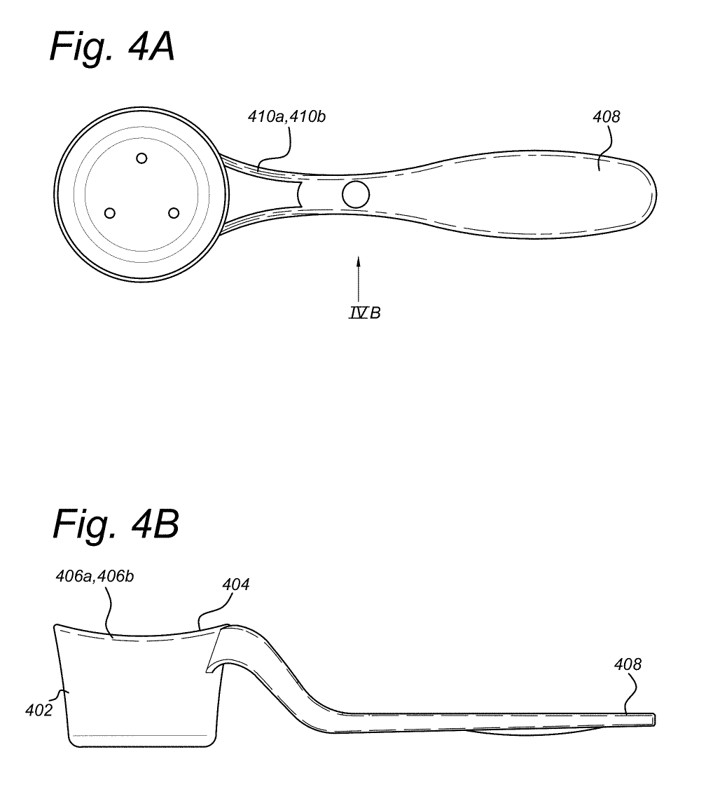

FIG. 4 shows a top view and a side view of scoop 400 with a bowl 402. The bowl 402 having an opening 404 and having concave sides 406a, b, and a height at the frontal area 404 and at the rear area 406 which is greater than the height of the sides 402a, b. The scoop has a handle 408 that is attached at an upper area of the scoop bowl 402. The handle is bifurcated into two parts 410a, b.

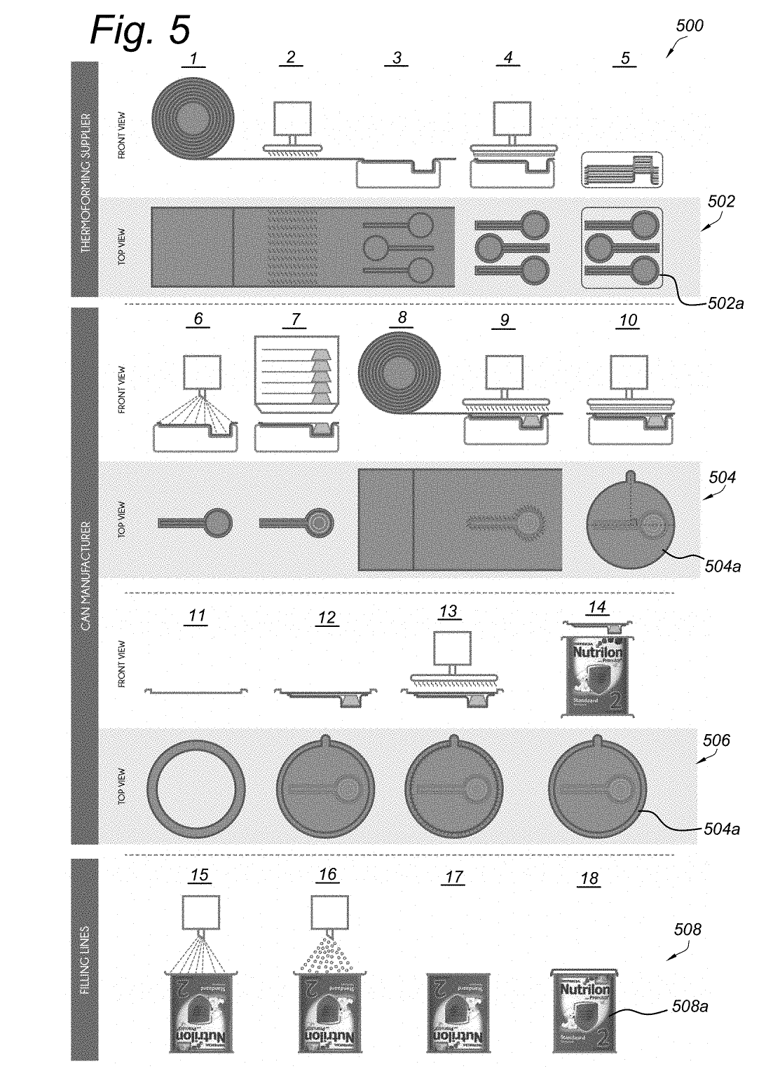

FIG. 5 shows various processes of manufacture of various embodiments according to the invention. In a process 502, a blister matrix 502a is formed, containing a plurality of blisters, each blister holding a scoop.

In a process 504, a blister and seal combination 504a is formed, wherein a blisters each containing a scoop are respectively attached to a seal.

In a process 506, a blister and seal combination (such as 504a above) is attached to a rim of an empty can, which can is not provided with a bottom panel.

In a process 508, a can (such as the can 506a) is filled with a powdered nutritional product through its bottom opening. A bottom panel is subsequently attached to the bottom edge of the can, and a lid for closing the can is applied. The present invention has been described above with reference to a number of exemplary embodiments as shown in the drawings. Modifications and alternative implementations of some parts or elements are possible, and are included in the scope of protection as defined in the appended claims.

1-22. (canceled)

23. A container for a powdered nutritional product, the container comprising:
a can having a base and an upstanding sidewall defining an interior space, the sidewall extending to a rim defining an opening to the interior space;
a seal and blister element combination, wherein the seal is attached to the rim to sealingly close the opening and the blister element is attached to an underside of the seal, whereby a scoop recess is formed between the blister element and the seal and the seal and blister element combination can be removed as a single element to gain access to the interior space; and
a scoop, sealed within the scoop recess, the scoop having a minor dimension and a major dimension.

24. The container according to claim 23, further comprising a lid, connectable to the can to cover the seal or to close the opening.

25. The container according to claim 23, wherein a height between an underside of the lid and an upper surface of the seal is less than the minor dimension of the scoop.

26. The container according to claim 23, wherein the seal comprises a pull-tab for peeling off the seal and blister element combination from the can.

27. The container according to claim 26, wherein the scoop recess is elongate and the pull-tab is provided in a substantially perpendicular relation to a longitudinal axis of the blister element.

28. The container according claim 23, wherein the blister element is formed of polyethylene terephthalate (PET).

29. The container according to claim 23, wherein the seal comprises aluminum.

30. The container according to claim 23, further comprising a quantity of infant formula within the interior space.

31. The container according to claim 24, wherein the lid has an upper part and a lower part, wherein the lower part has a greater radius than the upper part, and wherein the radius of the upper part is smaller than a radius of the rim of the can.

32. The container according to claim 31, wherein the upper part of the lid has a profiled outer circumference that is complementary with the base of the container, allowing stacking therewith.

33. The container according to claim 24, wherein the lid comprises a holding element for holding a scoop.

34. The container according to claim 33, wherein the holding element comprises a pin extending from the underside of the lid arranged to hold the scoop in any diametric orientation with respect to the lid.

36. The container according to claim 23, wherein the can is a tin can having a circular cross-section and a diameter between 9 and 12 cm.

37. A scoop for dosing powdered infant formula for use with the container of claim 23, the scoop comprising a bowl, open at its upper part and having one or more openings extending through a lower part of the bowl, a handle attached to the upper part of the bowl, the handle extending downwardly away from the bowl forming a downward extension until reaching a deflection point, and extending horizontally away from the bowl from said deflection point thereby forming a horizontal extension, extending parallel to the lower part of the bowl.

38. The scoop according to claim 37, wherein the downward extension has a curvature.

39. The scoop according to claim 37, wherein the downward extension of the handle is at least partly bifurcated into two sub-extensions, so that the handle is attached to the bowl at two separate locations, and wherein each of said two sub-extensions has a width that is smaller than a width of the horizontal extension of the handle.

40. The scoop according to claim 37, comprising an opening in the horizontal extension of the handle for attaching the scoop to an underside of a lid.

41. The scoop according to claim 37, wherein a height of the bowl increases gradually from a central point on sides of the bowl towards a front of the bowl and towards the handle of the scoop, thereby forming concave, curved sides, so that the scoop can be leveled against a rim of a can.

42. A container for a powdered nutritional product, the container comprising:
a can having a base and an upstanding sidewall defining an interior space, the sidewall extending to a rim defining an opening to the interior space;
a seal and blister element combination, attached to the rim to sealingly close the opening and comprising a scoop recess formed between the blister element and the seal;
a scoop, sealed within the scoop recess, the scoop comprising a bowl, open at its upper part, a handle attached to the upper part of the bowl, the handle extending downwardly away from the bowl forming a downward extension until reaching a deflection point, and extending horizontally away from the bowl from said deflection point thereby forming a horizontal extension, extending parallel to the lower part of the bowl; and
a lid, connectable to the can to cover the seal and close the opening, the lid comprising a pin extending from the underside of the lid arranged to hold the scoop in any diametric orientation with respect to the lid, with the bowl opening downwards.
